(19) United States
(12) Patent Application Publication
(10) Pub. No.: US 2024/0070563 A1
(43) Pub. Date: Feb. 29, 2024

(54) SYSTEMS AND METHODS FOR FORECASTING UTILIZING LAGGED AND CORRELATED DATA SETS

(71) Applicant: THE BANK OF NEW YORK MELLON, New York, NY (US)

(72) Inventor: Nikhil Ranjan GARGE, Pune (IN)

(21) Appl. No.: 17/978,537

(22) Filed: Nov. 1, 2022

(30) Foreign Application Priority Data
Aug. 31, 2022 (IN) 202241049682

(51) Int. Cl. G06Q 10/04; G06N 5/02

(52) U.S. Cl. CPC G06Q 10/04; G06N 5/022

(57) ABSTRACT

Systems, software, and methods are disclosed for generating a prediction of time-series data from data sets. A system is configured to: retrieve, for each product of a set of products, the time-series data including time-value pairs; select a first product; compute a correlation value between the first product and other products and for one or more degrees of lag to obtain a set of correlation values representing the correlations between the first product to the other products assessed at prior times; select a subset of products based at least in part on the correlation values; provide the time-series data associated with each product from the subset of products and the first product to a machine learning model trained to predict a future value of the first product based on values of the subset of products; and obtain prediction data representing a set of predicted values for the first product.

### CROSS-REFERENCE TO RELATED APPLICATIONS

This application claims priority to India Patent Application No. 202241049682, filed Aug. 31, 2022, the subject matter of which is incorporated herein by reference in entirety.

### DESCRIPTION OF THE RELATED ART

Predicting future values of data may be performed by machine learning algorithms. In many cases, the datasets contain large number products (each product representing a time series sequence), and the goal is to forecast values for each product. In a system of large number of products, training machine learning on each product independently can be inefficient and may result in less accurate predictions of future data. Additionally, existing systems (leveraging interactions between products) are difficult to implement on datasets with large number of products. Also, these existing systems typically provide for building, at most, one global forecasting model—across all products—trying to explain variation (or fitting) across multiple/different products. However, in an attempt to explain variation across all products, a global model may resort to generating forecasts with mediocre accuracy across all products.

### SUMMARY

Systems, software, and methods are disclosed for generating a prediction of time-series data from data sets. In one aspect, a system includes memory storing computer program instructions; and one or more processors configured to execute the computer program instructions to: retrieve, for each product of a set of products, the time-series data including a plurality of time-value pairs; select a first product from the set of products; compute a correlation value between the first product and a plurality of other products from the set of products and for one or more degrees of lag to obtain a set of correlation values representing the correlations between the first product to the plurality of other products assessed at prior times; select a subset of products from the set of products based at least in part on the correlation values; provide the time-series data associated with each product from the subset of products and the first product to a machine learning model trained to predict a future value of the first product based on values of the subset of products at the prior times; and obtain, from the machine learning model, prediction data representing a set of predicted values for the first product at one or more future times.

In some variations, the machine learning model can be configured to generate the prediction data for only the first product. The machine learning model can be configured to generate the prediction data for the first product and one or more of the plurality of other products but not for all of the plurality of products.

In some variations, the system can be further configured for determining a ranking of correlation values from the set of correlation values, wherein the ranking of correlation values indicates which products from the set of products have data trends that are most strongly correlated with a first data trend of the first product, wherein the subset of products have the top N correlation values from the ranking. The subset of products can have correlation values exceeding a correlation threshold.

In some variations, a regression model that predicts the future values as implemented by the machine learning model can include a random error term. The correlation value can be computed using Spearman's correlation coefficient.

In some variations, the system can be further configured for selecting the machine-learning model based on data dimensions of the time-series data for the set of products, wherein: when the data dimensions of the time-series data have 2-40 time points per series, select LASSO, when the data dimensions of the time-series data have 40-5000 time points per series, select Random Forests, and when the data dimensions of the time-series data have 5000 or more time points per series, select Deep Learning.

In some variations, the time-series data can include first time-series data associated with the first product and second time-series data associated with a second product from the set of products; the first time-series data can include a first plurality of time-value pairs, wherein each time-value pair of the first plurality of time-value pairs represents a value associated with the first product at each of a first set of times; the second time-series data can include a second plurality of time-value pairs, wherein each time-value pair of the second plurality of time-value pairs represents a value associated with the second product at each of a second set of times; the first set of times being discrete and captured at a first temporal frequency; the second set of times being discrete and captured at a second temporal frequency; the first temporal frequency and the second temporal frequency differ.

In some variations, the system can be configured to generate intermediate values for the second product at each of the first set of times of which there is no corresponding value for the second product from the second plurality of time-value pairs, wherein the intermediate values are determined by interpolating the second plurality of time-value pairs at each of the first set of times of which there is no corresponding value for the second product from the second plurality of time-value pairs.

In an interrelated aspect, a non-transitory computer readable medium has instructions recorded thereon for generating a prediction of time-series data from data sets, the instructions when executed by a computer having at least one programmable processor cause any of the above operations.

In an interrelated aspect, a method for implementation by at least one programmable processor includes any of the above operations.

Implementations of the current subject matter may include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also contemplated that may include one or more processors and one or more memories coupled to the one or more processors. A memory, which may include a computer-readable storage medium, may include, encode, store, or the like, one or more programs that cause one or more processors to perform one or more of the operations described herein. Computer implemented methods consistent with one or more implementations of the current subject matter may be implemented by one or more data processors residing in a single computing system or across multiple computing systems. Such multiple computing systems may be connected and may exchange data and/or commands or other instructions or the like via one or more connections, including but not limited to a connection over a network (e.g., the internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to particular implementations, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram illustrating a simplified computing system in accordance with certain aspects of the present disclosure.

FIG. 2 is a diagram illustrating generating predictions utilizing correlated lagged data in accordance with certain aspects of the present disclosure.

FIG. 3 is a diagram illustrating utilizing data with up to three different degrees of lag for predicting a future data value in accordance with certain aspects of the present disclosure.

FIG. 4 is a diagram illustrating utilizing data with up to two different degrees of lag for predicting a future data value in accordance with certain aspects of the present disclosure.

FIG. 5 is a diagram illustrating utilizing data with one degree of lag for predicting a future data value in accordance with certain aspects of the present disclosure.

FIG. 6 is a diagram illustrating an example method of predicting a future value of a product utilizing lagged data in accordance with certain aspects of the present disclosure.

FIG. 7 is a diagram illustrating an example machine learning model in accordance with certain aspects of the present disclosure.

FIG. 8 is a visualization of an example dashboard showing example results in accordance with certain aspects of the present disclosure.

### DETAILED DESCRIPTION

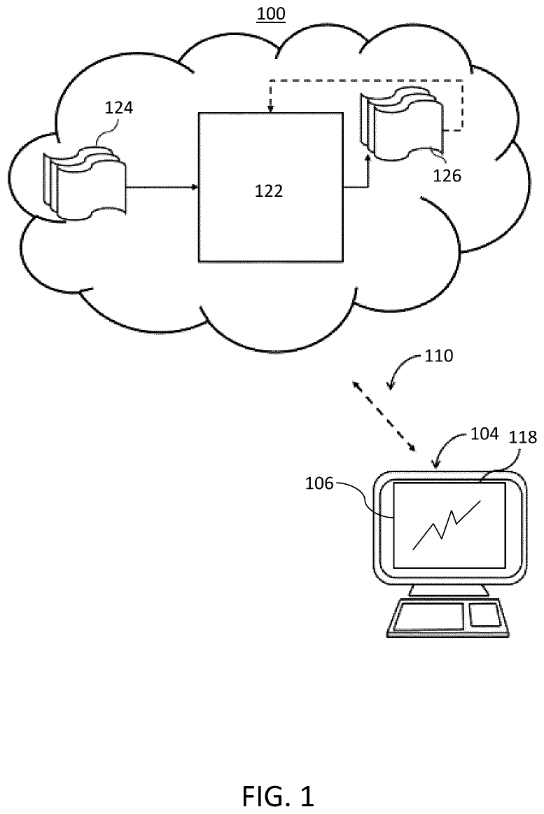

FIG. 1 is a diagram illustrating a simplified computing system in accordance with certain aspects of the present disclosure.

In some embodiments, system 100 may use one or more prediction models to generate predictions for requested data at a future time. For example, as shown in FIG. 1, system 100 may receive a request for a prediction, for example via a user interface 106 that may communicate with machine learning model 122. The system may output a predicted value for the data as output 118 on client device 104. In some embodiments, machine learning model 122 may be of various types, for example, LASSO, Random Forests, etc.

Machine learning model 122 may take inputs 124 and provide outputs 126. The inputs may include multiple data sets, such as a training data set and a test data set. In one use case, outputs 126 may be fed back to machine learning model 122 as input to train machine learning model 122 (e.g., alone or in conjunction with user indications of the accuracy of outputs 126, labels associated with the inputs, or with other reference feedback information). In another use case, machine learning model 122 may update its configurations (e.g., weights, biases, or other parameters) based on its assessment of its prediction (e.g., outputs 126) and reference feedback information (e.g., user indication of accuracy, reference labels, or other information). In another use case, where machine learning model 122 is a neural network, connection weights may be adjusted to reconcile differences between the neural network's prediction and the reference feedback. In a further use case, one or more neurons (or nodes) of the neural network may require that their respective errors are sent backward through the neural network to them to facilitate the update process (e.g., backpropagation of error). Updates to the connection weights may, for example, be reflective of the magnitude of error propagated backward after a forward pass has been completed. In this way, for example, the machine learning model 122 may be trained to generate better predictions.

FIG. 1 also depicts communication paths 110. Communication path 110 may include the Internet, a mobile phone network, a mobile voice or data network (e.g., a 4G, 5G, or LTE network), a cable network, a public switched telephone network, other types of communications network, or combinations of communications networks. Communication path 110 may separately or together include one or more communications paths, such as a satellite path, a fiber-optic path, a cable path, a path that supports Internet communications (e.g., IPTV), free-space connections (e.g., for broadcast or other wireless signals), any other suitable wired or wireless communications path, or combination of such paths. The computing devices of system 100 may include additional communication paths linking multiple hardware, software, and/or firmware components operating together. For example, the computing devices may be implemented by a cloud of computing platforms operating together as the computing devices.

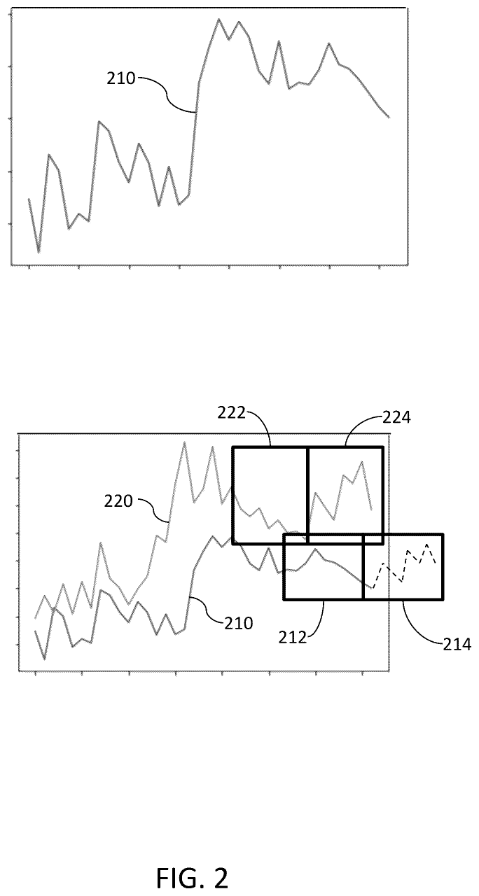

FIG. 2 is a diagram illustrating generating predictions utilizing correlated lagged data in accordance with certain aspects of the present disclosure.

The present disclosure provides embodiments for improved prediction of future data values utilizing lagged data. As used herein, the term “lagged” means data that is separated in time from other data. The lagged data may have some degree of correlation to each other, but no particular degree of correlation is essential. One example of utilizing lagged data is depicted in FIG. 2. The top plot in FIG. 2 depicts example first data 210 showing the value (y-axis) over time (x-axis). The bottom plot adds second data 220 having different time-value pairs. It may be determined by the system that, when accounting for lag between the two data sets, a meaningful correlation may be found. For example, first data 210 may be well-correlated, but lagging, second data 220 such that their correlation may be significant upon shifting a time base of the first data 210 or second data 220. In the example of FIG. 2, the correlation between the data may be seen in that both sets of data have a flat period, followed by a sharp increase, followed by a slow decrease.

Such correlated timeseries data may be utilized to predict future values for lagged data. For example, in FIG. 2, the data in first known region 212 of first data 210 may be well-correlated to the corresponding data in second known region 222 of second data 220. In this example first data 210 also include first unknown region 214, which may represent a time range outside the available data set and for which a prediction of future values is desired. However, with an appropriate shift in the time base (or equivalent extraction of corresponding time value pairs), the data from second known region 224 may be utilized to predict future data (shown by the dashed lines) in first unknown region 214.

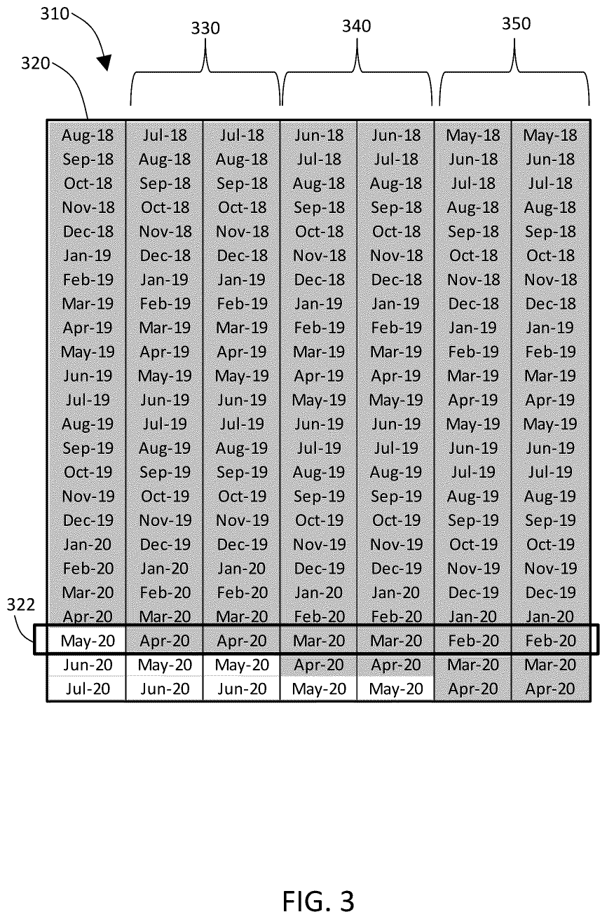

FIG. 3 is a diagram illustrating utilizing data with up to three different degrees of lag for predicting a future data value in accordance with certain aspects of the present disclosure. Table 310 is an example of available data at a particular time, in this case up through April 2020. The shaded regions represent past times for which the value of the data is known, and the unshaded regions represent unknown or future data. In this example, data is known up through April 2020, but not for May 2020 or later.

Table 310 in FIG. 3 also depicts multiple data sets (330, 340, 350) that have three different degrees of lag relative to first data set 320. Second data set 330 is shown here to include two sets of timeseries data, for example, as could be obtained from two different sources. In this example, both sets of timeseries data in second data set 330 may have the same time base. The system may perform a correlation analysis between any timeseries data, and it may be determined that the two data sets are well-correlated when a first degree of lag is accounted for. In this example, the second data set 330 was found to be well-correlated with first data set 320 but with a one-month lag between the well-correlated features. Accordingly, the first data set 320, having a value that is unknown in May 2020, may be predicted at least in part by the values of second data set 330 from April 2020. Third data set 340 may represent similarly well-correlated data but with a two-month lag. Fourth data set 350 may represent yet further well-correlated data with a three-month lag. The cumulative data used for prediction of the value in May 2020 of first data set 320 is shown by the selected field 322.

For example, in one embodiment, the data in FIG. 3 may be representative of inflows and outflows available for multiple investment styles through April 2020. By implementing embodiments as described herein, the systems and methods may forecast net-flows for May, June, and July 2020. For example, for a specific product A, assume investment styles B (at lag 1, 330), C (at lag 1, 330), D (at lag 2, 340), E (at lag 2, 340), F (at lag 3, 350), and an environmental, social, and governance factors (ESG) metric ‘carbon rating’ (at lag 3, 350) are identified as being highly correlated with product A. As the data shows, the net-flows of investments B (lag 1, 330), C (lag 1, 330), D (lag 2, 340), E (lag 2, 340), F (lag 3, 350), and ESG metric (lag 3, 350) may be used as predictors to forecast and/or predict net-flows (of product A) for May, June, and July 2020.

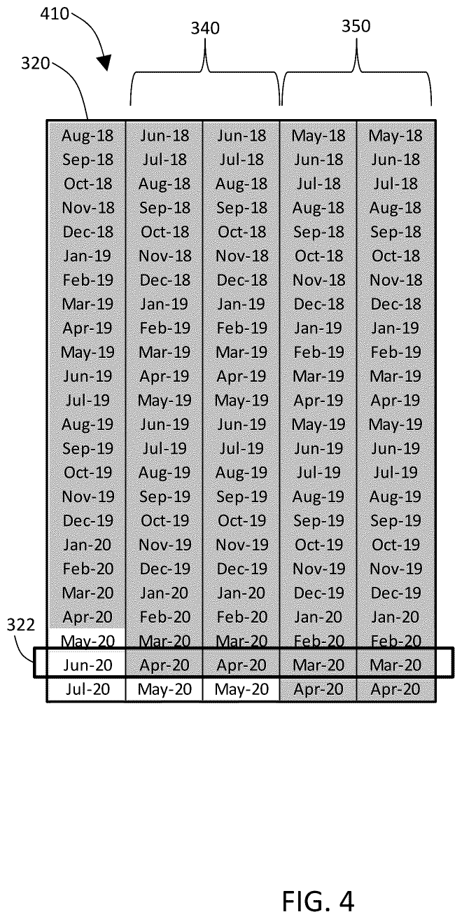

FIG. 4 is a diagram illustrating utilizing data with up to two different degrees of lag for predicting a future data value in accordance with certain aspects of the present disclosure. FIG. 4 depicts table 410 that includes first data set 320, third data set 330, and fourth data set 350. Similar to the example of FIG. 3, a prediction may be determined for June 2020 of first data set 320. However, because prior second data set 330 was only correlated given a one-month lag, it is not used in this prediction, which requires data correlated given at least a two-month lag to predict unknown values two months out. Accordingly, for June 2020 predictions, third data set 340 and fourth data set 350 may be utilized but not second data set 330. Field 322 may then include the depicted data for predicting the June 2020 value.

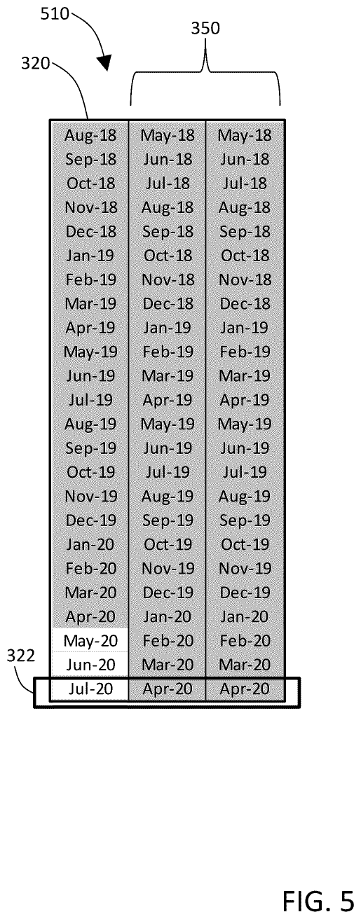

FIG. 5 is a diagram illustrating utilizing data with one degree of lag for predicting a future data value in accordance with certain aspects of the present disclosure. FIG. 5 depicts table 510 that includes first data set 320 and fourth data set 350. Continuing the examples of FIG. 3 and FIG. 4, for a prediction of a value in July 2020 (three months out), only fourth data set 350 has the required three-month lag. Field 322 again shows the utilized data from fourth data set 350 (from April 2020) to predict the value of first data set 322 months out.

As applied to the example embodiment described above, only lag 3 correlations (F, ESG) will be helpful in forecasting 3 months ahead (i.e., July 2020). Predictors with lag 2 and lag 3 correlations will be helpful in predicting a 2-month ahead forecast (June 2020). And predictors with lag 1, 2, and 3 correlations will be helpful in forecasting one month ahead (May 2020).

Furthermore, to forecast net-flows 3 months ahead, embodiments may use three models: (1) one that uses lagged 3 correlations to predict a 3-month ahead forecast; (2) one that uses lagged 2 and lagged 3 correlations to predict a 2-month ahead forecast; and (3) one that uses all lagged correlations as predictors to predict a 1-month ahead forecast. In some embodiments, the systems and methods described herein may use one or more machine learning methods (e.g., LASSO, Random forests, deep learning, etc.) to predict forecasts for various products (e.g., Product A).

The above example shows how forecasts may be generated for one product (A) and how ESG may play a role in forecasting. The same or a similar process may be implemented for each product—i.e., first identifying strong cross product correlators and building models to generate forecast(s) for each target product. In various embodiments, one or more of a plurality of different ESG data points or metrics may be used in the forecasting. For example, in some embodiments, ESG data may relate to carbon metrics such as, for example, carbon risk, fossil fuel, oil & gas, emissions, and thermal coal power generation, among others. In some embodiments, ESG data may relate to ESG fund ratings such as, for example, environmental risk scores, social risk scores, governance risk scores, sustainability scores, and ESG exposure scores, among others.

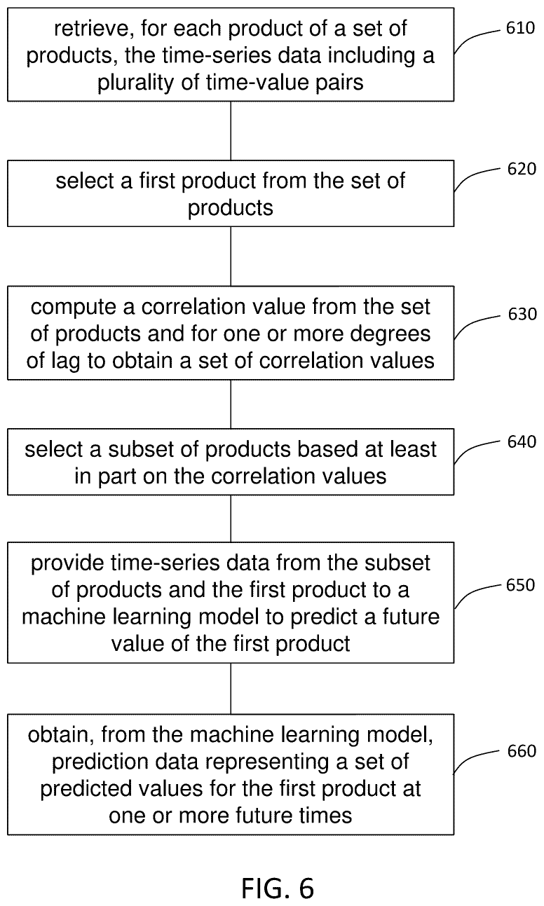

FIG. 6 is a diagram illustrating an example of a method of predicting a future value of a product utilizing lagged data in accordance with certain aspects of the present disclosure.

The present disclosure includes numerous embodiments that provide technical improvements for accurate and computationally efficient prediction of values of data. In an embodiment, a system for generating a prediction of time-series data from data sets may include memory storing computer program instructions and one or more processors configured to execute the computer program instructions perform any of the operations depicted in FIG. 6.

At 610, the system may retrieve, for each product of a set of products, the time-series data including time-value pairs. As used herein, the term “product” can include, for example, funds with particular investment styles such Commodities in Precious Metals, Communications, Consumer Cyclical, Consumer defensive, etc. that may have performance over time, an amount of a type of good over time, a temperature over time, a location over time, etc. Similarly, “time-value pairs” may be data points that together form the time-series data, such as depicted by the examples in FIGS. 2-5. The number of products for which timeseries data may be retrieved may be as few as two. A “product” can also include metrics associated with another product. One example of a metric can account for environmental, social, and governance factors (ESG), and which may be indicative of trends in the same manner as other more directly financial metrics such as historical prices/values. As noted herein, ESG metrics may include, for example, carbon metrics, ESG fund ratings metrics, ESG product involvement metrics, etc.

At 620, the system may select a first product from the set of products. The selection may be in response to user input, for example, selecting a specific product for which a prediction of some future values is desired. The user input may be from, for example, interaction with client device 104. The selection may also be automatic, such as sequentially selecting a first product from a collection of products, then selecting the next, and so on.

At 630, the system may compute a correlation value between the first product and one or more of the other products from the set of products and for one or more degrees of lag to obtain a set of correlation values representing the correlations between the first product to the of other products assessed at prior times. Examples of such were provided in FIGS. 3-5, where in those examples, the first product may correspond to first data set 320 and the other products may correspond to one or more of second data set 330, third data set 340, and fourth data set 350. In those examples, it was presupposed that those data sets were sufficiently correlated as described. Details of the calculation of the correlation value are provided further herein.

At 640, the system may select a subset of products from the set of products based at least in part on the correlation values. In some embodiments, the system may have a preset correlation threshold, or one may be entered by a user via client device 104, that may determine which of the set of products are used for predicting a future value for the first product. For example, a low correlation threshold may allow use of a larger data set for use by the predictive methods described herein. In some embodiments, a larger data set may facilitate more robust predictions. In other embodiments, a higher correlation threshold may facilitate accurate predictions even with utilization of a smaller data set. In various embodiments, correlation thresholds may be set to any value between e.g., 0.3 and 0.99, with values between 0.5 and 0.6 preferred in some embodiments to provide a balance between robustness and predictive accuracy.

In some embodiments, the best hyper-parameter combination (correlation threshold (cth) and number of predictors (z)) can be selected based on how the model performs on validation sets. For example, data can be split into “training”, “validation” and “test” sets. The training set may contain, for example, January 2018-November 2020 (35 months) of data, validation set may contain December 2020-May 2021 (6 months) of data, and the test set may contain June 2021-November 2021 (last 6 months) of data. Additional and/or alternate sets may be used within the scope of this disclosure. The following hyper parameter values tested could include cth=0.45, 0.5, 0.55, and, for z=15, 25. In such an embodiment, the parameter combination cth=0.55 and z=25 may provide the highest accuracy on validation set and hence may be selected for generating forecasts.

The range of cth and z values to be considered can vary depending on data size and the machine learning approach under consideration. In one embodiment, z can be limited to 25 when, for example, data size is only somewhat larger (e.g., 35) and where applying a Random forests approach (which will use a random subset (e.g., 1/3^{rd} of 25) predictors in building each tree model). In embodiments utilizing LASSO z may be <15 (since we have 35 observations in data). The cth can be restricted to a certain value such as 0.55 where if at higher threshold cth , the method may be able to identify any predictors for many target products.

At 650, the system may provide the time-series data associated with (a) each product from the subset of products and (b) the first product, to a machine learning model trained to predict a future value of the first product based on values of the subset of products at the prior times.

As disclosed herein, various embodiments can utilize correlations between lagged data and a target data set to generate forecasts or predictions of future values in the target data set. Training the machine learning models to generate the predictions necessarily require a machine and can include such methods as gradient descent approach to fine-tune model parameters through iterative processes.

Compared to approaches such as exponential smoothing, Bayesian structural time series (BSTS), Facebook Prophet, and ARIMA, the example embodiments described herein provide a non-linear modelling approach with flexibility in choosing the number of features and applying an appropriate machine learning method depending upon the dimensions of the data in a given project. Furthermore, embodiments described herein provide greater insight into the existence of more variation in the data by building one forecasting model per entity or product, thus generating more accurate forecasts on specific products (i.e., since models may be trained at an individual product-level). For example, certain businesses, such as e-commerce ones, may use “wider” datasets—with large number of products and far fewer historical time points (of sales/revenue or units sold per day, etc.) per product. Understanding interactions between the sales of these innumerable products using lagged-cross-correlations as described herein may help these businesses to identify product flows that act as lead indicators of sales for other products. The forecasting approach as described herein provides an improvement to previous approaches in terms of its applicability in “wider” datasets—with large number of entities (or time series sequences) and far fewer data points per entity.

Embodiments of the systems and methods described herein may leverage cross-product interactions to generate forecasts across multiple products. The cross-series interactions between the first product and the subset of products can be particularly helpful in generating predictions in embodiments where the number of time points in the time-series may be limited. The disclosed methods herein are thus well-suited to utilizing time-series data over a number of different series, but with comparatively few time entries per series. For example, some conventional methods like simple/double/triple exponential smoothing may fail to produce accurate forecasts when time series is short (e.g., below sample size 50). Other methods like vector autoregression may fail when there are 100s (or more) time series sequences. In contrast, the methods of the present disclosure can provide accurate predictions when the given time series are short (e.g., 50 or less time points) as well as when data has 100s (or 1000s) of time series sequences.

At 660, the system may obtain, from the machine learning model, prediction data representing a set of predicted values for the first product at one or more future times. In the examples of FIGS. 3-5, the set of predicted values (e.g., for the future times of the values at May, June, and July 2020) may be obtained for the first data set 320.

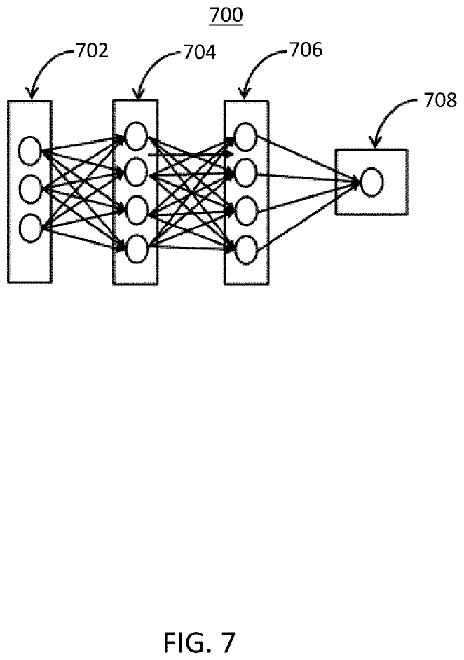

FIG. 7 is a diagram illustrating an example of a machine learning model in accordance with certain aspects of the present disclosure. Machine learning model 700 illustrates an example of an artificial neural network. Machine learning model 700 may include input layer 702 and may include one or more hidden layers (e.g., hidden layer 704 and hidden layer 706). Machine learning model 700 may be based on neural units (or artificial neurons). Each neural unit of machine learning model 700 may be connected with many other neural units of machine learning model 700. Such connections may be enforcing or inhibitory in their effect on the activation state of connected neural units. In some embodiments, each individual neural unit may have a summation function, which may combine the values of all of its inputs together. In some embodiments, each connection (or the neural unit itself) may have a threshold function such that the signal must surpass before it propagates to other neural units. Machine learning model 700 may be self-learning and trained, rather than explicitly programmed, and may perform significantly better in certain areas of problem solving, as compared to traditional computer programs. During training, output layer 708 may correspond to a prediction of a future value, and an input known to predict that value may be input into input layer 702. In some embodiments, machine learning model 700 may include multiple layers (e.g., where a signal path traverses from front layers to back layers). In some embodiments, back-propagation techniques may be utilized by machine learning model 700 where forward stimulation is used to reset weights on the “front” neural units.

In some embodiments, the machine learning model may be configured to generate the prediction data for only the first product. Such an embodiment contrasts with building one global machine learning model that may be trained to provide predictions for all products. By training the machine learning model to provide accurate predictions for a single product, the accuracy of the machine learning model may be substantially improved over other ‘global’ machine learning models trained to provide predictions across all available products.

In some embodiments, the machine learning model may be configured to generate the prediction data for the first product and one or more of the other products but not for all of the products. Such an embodiment may be a compromise between training a machine learning model to predict for one product as compared to all available products. Such embodiments may result in a trade-off between the breadth of applicability of the trained machine learning model and the accuracy of the predicted future values.

In some embodiments, the system may determine a ranking of correlation values from the set of correlation values. The ranking of correlation values may indicate which products from the set of products have data trends that are most strongly correlated with the data trend of the first product. For example, a system with a large number of products (e.g., online retail with multiple products, banking system with multiple financial products, etc.) with far fewer time points (or data points) per entity may benefit from implementing a system of determining a ranking of correlation values from the set of correlation values as described herein. In some embodiments, a correlation value ρ₋ₖ^{xy} may be calculated via Eq. 1 (Spearman's correlation coefficient) to quantify how values of product y (at time t) are correlated with product x (at time t−k):

$${ρ}_{- k}^{xy} = \frac{\frac{1}{n} {\sum }_{t = 1 + k}^{n} ( R ( {y}_{t} ) - R \overline{( y )} ) \cdot ( R ( {x}_{t - k} ) - R \overline{( x )} )}{\sqrt{\frac{1}{n} {\sum }_{t = 1 + k}^{n} {( R ( {y}_{t} ) - \overline{R ( y )} )}^{2}} \sqrt{\frac{1}{n} {\sum }_{t = 1 + k}^{n} {( R ( {x}_{t - k} ) - \overline{R ( x )} )}^{2}}} \qquad ( Eq . 1 )$$

where: x and y are two products, each with a time series sequence, R(x) and R(y) are ranks for products x and y, and [symbol] and [symbol] are mean ranks. Eq. 1 thus quantifies (ρ) how strongly the product x at lag k is cross correlated with y. In other words, the above equation may quantify the degree to which past values of product x (at lag k) are correlated with current values of product y. The ranking of correlation values may then be based on the computed correlation values. In some embodiments, the correlation value may be computed using Spearman's correlation coefficient.

In various embodiments, the subset of products used by the machine learning model may have the top N correlation values from the ranking, with N being any number present in the system or selected by a user. In the example of FIG. 3 the machine learning model may utilize the timeseries data top two correlation values (for each of data sets 330-350). In some embodiments, the subset of products may have correlation values exceeding a correlation threshold. The correlation threshold may therefore provide an additional constraint on the data sets that may be used for prediction.

In some embodiments, for any given product (e.g., product Y) for which a prediction for some data is requested, an algorithm for doing such may include:
For x in (products Xₗ . . . Xₚ):
   For k in (lags l . . . L):
      Compute lag-correlations ρ₋ₖ^{xy}

yₜ=v(L)X₁ₜ+v(L)X₂ₜ+v(L)X₃ₜ+. . . +v(L)Xₚₜ (Eq. 2)

with yₜ being a future value at time t, where each term above may be computed via (e.g., for v(L)X₁ₜ):

v(L).X₁ₜ=v₁X₁ₜ₋₁+v₂X₁ₜ₋₂+. . . +v_{L}X_{1t-L} and vₖ=0, if|ρ₋ₖ^{x1y}|<cth (Eq. 3)

and so on for the other terms, with cth being the correlation threshold (if used in the embodiment).

In various embodiments, the system may include a regression model (e.g., yₜ, above) that predicts the future values as implemented by the machine learning model may include a random error term. Such a term can be included to represent how far the prediction is believed to be from ground truth.

In some embodiments, the system may select the machine-learning model based on data dimensions of the time-series data for the set of products. For example, with a large number of data points per series, the system can apply complex ML approaches like Deep Learning (with appropriate number of predictors z) while with more limited number of time points per series (e.g., 50s—low 1000s), the system may apply methods like LASSO and Random Forests. As one example, when the data dimensions of the time-series data have 2-40 time points per series, select LASSO. When the data dimensions of the time-series data have 40-5000 time points per series, apply Random Forests. When the data dimensions of the time-series data have 5000 or more (e.g., 100k) time points per series, apply Deep Learning.

In some embodiments, to enable utilization of data sets that may have missing or mismatched time-series data, data may be interpolated, extrapolated, or otherwise adjusted to synchronize the at least a portion of the data sets. For example, in an embodiment, the time-series data may include first time-series data associated with the first product and second time-series data associated with a second product from the set of products. The first time-series data may include a first time-value pairs, where each time-value pair of the first time-value pairs represents a value associated with the first product at each of a first set of times. The second time-series data may include second time-value pairs, where each time-value pair of the second plurality of time-value pairs represents a value associated with the second product at each of a second set of times. The first set of times may be discrete and captured at a first temporal frequency (e.g., monthly). The second set of times may be discrete and captured at a second temporal frequency (e.g., weekly). Thus, in general, the first temporal frequency and the second temporal frequency may differ.

In certain embodiments, the system may generate intermediate values for the second product at each of the first set of times of which there is no corresponding value for the second product from the second time-value pairs, where the intermediate values may be determined by interpolating the second time-value pairs at each of the first set of times of which there is no corresponding value for the second product from the second time-value pairs.

Embodiments of the various systems and methods described herein provide a forecasting approach (1) that explores interactions between multiple entities and can be implemented in a system with large number of products, especially when time series is short; (2) that allows one to select features—lagged values of different products and/or entities—to potentially improve forecasting accuracy; (3) uses a non-linear modelling approach (and is not restricted to linear modelling methods); (4) that allows developing one forecasting model per product (with other products as predictors), which can potentially explain more variation in data; and/or (5) that offers flexibility to apply appropriate machine learning method (ex: LASSO, Random Forests, etc.) depending on the resulting data size.

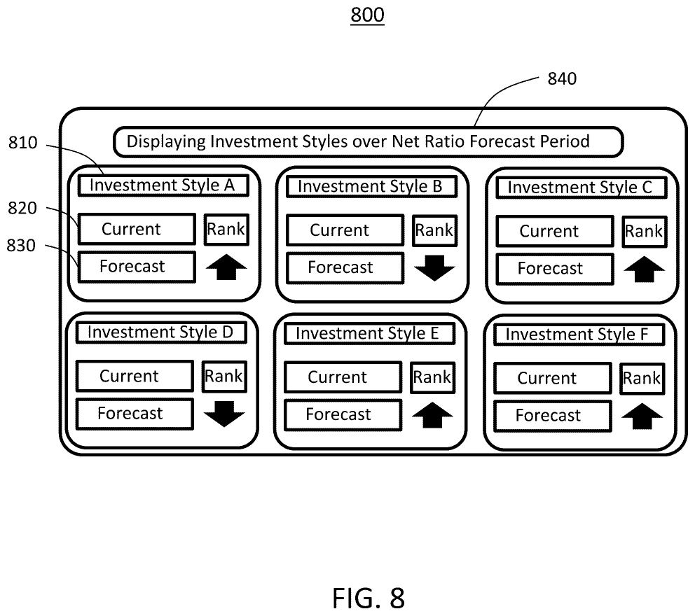

FIG. 8 is an example visualization of a dashboard 800 showing results in accordance with certain aspects of the present disclosure. In some embodiments, a display may be generated based on implementation of one or more of the systems and methods described herein. As shown in FIG. 8, a plurality of products 810 may be displayed simultaneously, each showing a current value 820 and a forecasted value 830. In some embodiments, forecasts may be calculated and/or displayed based on a pre-selected net ratio forecast period 840, e.g., 3 months, 2 months, etc.

In the following, further features, characteristics, and example technical solutions of the present disclosure will be described in terms of items that may be optionally claimed in any combination:

Item 1: A system for generating a prediction of time-series data from data sets, the system comprising: memory storing computer program instructions; and one or more processors configured to execute the computer program instructions to: retrieve, for each product of a set of products, the time-series data including a plurality of time-value pairs; select a first product from the set of products; compute a correlation value between the first product and a plurality of other products from the set of products and for one or more degrees of lag to obtain a set of correlation values representing the correlations between the first product to the plurality of other products assessed at prior times; select a subset of products from the set of products based at least in part on the correlation values; provide the time-series data associated with each product from the subset of products and the first product to a machine learning model trained to predict a future value of the first product based on values of the subset of products at the prior times; and obtain, from the machine learning model, prediction data representing a set of predicted values for the first product at one or more future times.

Item 2, the system of item 1, wherein the machine learning model is configured to generate the prediction data for only the first product.

Item 3, the system of any one of the preceding items, wherein the machine learning model is configured to generate the prediction data for the first product and one or more of the plurality of other products but not for all of the plurality of products.

Item 4, the system of any one of the preceding items, further comprising: determining a ranking of correlation values from the set of correlation values, wherein the ranking of correlation values indicates which products from the set of products have data trends that are most strongly correlated with a first data trend of the first product, wherein the subset of products have the top N correlation values from the ranking.

Item 5, the system of any one of the preceding items wherein at least one product of the set of products comprises an environmental, social, and governance (ESG) metric, and wherein the ESG metric is one of a carbon metric, an ESG fund ratings metric, or an ESG product involvement metric.

Item 6, the system of any one of the preceding items, wherein a regression model that predicts the future values as implemented by the machine learning model includes a random error term.

Item 7, the system of any one of the preceding items, wherein the correlation value is computed using Spearman's correlation coefficient.

Item 8, the system of any one of the preceding items, further comprising selecting the machine-learning model based on data dimensions of the time-series data for the set of products, wherein: when the data dimensions of the time-series data have 2-40 time points per series, select LASSO, when the data dimensions of the time-series data have 40-5000 time points per series, select Random Forests, and when the data dimensions of the time-series data have 5000 or more time points per series, select Deep Learning.

Item 9, the system of any one of the preceding items, wherein: the time-series data includes first time-series data associated with the first product and second time-series data associated with a second product from the set of products; the first time-series data comprises a first plurality of time-value pairs, wherein each time-value pair of the first plurality of time-value pairs represents a value associated with the first product at each of a first set of times; the second time-series data comprises a second plurality of time-value pairs, wherein each time-value pair of the second plurality of time-value pairs represents a value associated with the second product at each of a second set of times; the first set of times being discrete and captured at a first temporal frequency; the second set of times being discrete and captured at a second temporal frequency; the first temporal frequency and the second temporal frequency differ.

Item 10, the system of any one of the preceding items, wherein the one or more processors are further caused to: generate intermediate values for the second product at each of the first set of times of which there is no corresponding value for the second product from the second plurality of time-value pairs, wherein the intermediate values are determined by interpolating the second plurality of time-value pairs at each of the first set of times of which there is no corresponding value for the second product from the second plurality of time-value pairs.

Item 11: A method comprising utilization of the system of any one of items 1-10.

Item 12: A computer program product comprising computer program instructions configured to cause one or more processors to perform the instructions of any one of items 1-10.

The present disclosure contemplates that the calculations disclosed in the embodiments herein may be performed in a number of ways, applying the same concepts taught herein, and that such calculations are equivalent to the embodiments disclosed.

One or more aspects or features of the subject matter described herein may be realized in digital electronic circuitry, integrated circuitry, specially designed application specific integrated circuits (ASICs), field programmable gate arrays (FPGAs) computer hardware, firmware, software, and/or combinations thereof. These various aspects or features may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which may also be referred to programs, software, software applications, applications, components, or code, include machine instructions for a programmable processor, and may be implemented in a high-level procedural language, an object-oriented programming language, a functional programming language, a logical programming language, and/or in assembly/machine language. As used herein, the term “machine-readable medium” (or “computer readable medium”) refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” (or “computer readable signal”) refers to any signal used to provide machine instructions and/or data to a programmable processor. The machine-readable medium may store such machine instructions non-transitorily, such as for example as would a non-transient solid-state memory or a magnetic hard drive or any equivalent storage medium. The machine-readable medium may alternatively or additionally store such machine instructions in a transient manner, such as for example as would a processor cache or other random access memory associated with one or more physical processor cores.

To provide for interaction with a user, one or more aspects or features of the subject matter described herein may be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices may be used to provide for interaction with a user as well. For example, feedback provided to the user may be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein may be embodied in systems, apparatus, methods, computer programs and/or articles depending on the desired configuration. Any methods or the logic flows depicted in the accompanying figures and/or described herein do not necessarily require the particular order shown, or sequential order, to achieve desirable results. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations may be provided in addition to those set forth herein. The implementations described above may be directed to various combinations and subcombinations of the disclosed features and/or combinations and subcombinations of further features noted above. Furthermore, above described advantages are not intended to limit the application of any issued claims to processes and structures accomplishing any or all of the advantages.

Additionally, section headings shall not limit or characterize the invention(s) set out in any claims that may issue from this disclosure. Further, the description of a technology in the “Background” is not to be construed as an admission that technology is prior art to any invention(s) in this disclosure. Neither is the “Summary” to be considered as a characterization of the invention(s) set forth in issued claims. Furthermore, any reference to this disclosure in general or use of the word “invention” in the singular is not intended to imply any limitation on the scope of the claims set forth below. Multiple inventions may be set forth according to the limitations of the multiple claims issuing from this disclosure, and such claims accordingly define the invention(s), and their equivalents, that are protected thereby.

What is claimed is:

1. A system for generating a prediction of time-series data from data sets, the system comprising:
memory storing computer program instructions; and
one or more processors configured to execute the computer program instructions to:
retrieve, for each product of a set of products, the time-series data including a plurality of time-value pairs;
select a first product from the set of products;
compute a correlation value between the first product and a plurality of other products from the set of products and for one or more degrees of lag to obtain a set of correlation values representing the correlations between the first product to the plurality of other products assessed at prior times;
select a subset of products from the set of products based at least in part on the correlation values;
provide the time-series data associated with each product from the subset of products and the first product to a machine learning model trained to predict a future value of the first product based on values of the subset of products at the prior times; and
obtain, from the machine learning model, prediction data representing a set of predicted values for the first product at one or more future times.

2. The system of claim 1, wherein the machine learning model is configured to generate the prediction data for only the first product.

3. The system of claim 1, wherein the machine learning model is configured to generate the prediction data for the first product and one or more of the plurality of other products but not for all of the plurality of products.

4. The system of claim 1, further comprising:
determining a ranking of correlation values from the set of correlation values, wherein the ranking of correlation values indicates which products from the set of products have data trends that are most strongly correlated with a first data trend of the first product,
wherein the subset of products have the top N correlation values from the ranking.

5. The system of claim 1, wherein at least one product of the set of products comprises an environmental, social, and governance (ESG) metric, and wherein the ESG metric is one of a carbon metric, an ESG fund ratings metric, or an ESG product involvement metric.

6. The system of claim 1, wherein a regression model that predicts the future values as implemented by the machine learning model includes a random error term.

7. The system of claim 1, wherein the correlation value is computed using Spearman's correlation coefficient.

8. The system of claim 1, further comprising selecting the machine-learning model based on data dimensions of the time-series data for the set of products, wherein:
when the data dimensions of the time-series data have 2-40 time points per series, select LASSO,
when the data dimensions of the time-series data have 40-5000 time points per series, select Random Forests, and
when the data dimensions of the time-series data have 5000 or more time points per series, select Deep Learning.

9. The system of claim 1, wherein:
the time-series data includes first time-series data associated with the first product and second time-series data associated with a second product from the set of products;
the first time-series data comprises a first plurality of time-value pairs, wherein each time-value pair of the first plurality of time-value pairs represents a value associated with the first product at each of a first set of times;
the second time-series data comprises a second plurality of time-value pairs, wherein each time-value pair of the second plurality of time-value pairs represents a value associated with the second product at each of a second set of times;
the first set of times being discrete and captured at a first temporal frequency;
the second set of times being discrete and captured at a second temporal frequency;
the first temporal frequency and the second temporal frequency differ.

10. The system of claim 9, wherein the one or more processors are further caused to:
generate intermediate values for the second product at each of the first set of times of which there is no corresponding value for the second product from the second plurality of time-value pairs, wherein the intermediate values are determined by interpolating the second plurality of time-value pairs at each of the first set of times of which there is no corresponding value for the second product from the second plurality of time-value pairs.

11. A non-transitory computer readable medium having instructions recorded thereon for generating a prediction of time-series data from data sets, the instructions when executed by a computer having at least one programmable processor cause operations comprising:
retrieving, for each product of a set of products, the time-series data including a plurality of time-value pairs;
selecting a first product from the set of products;
computing a correlation value between the first product and a plurality of other products from the set of products and for one or more degrees of lag to obtain a set of correlation values representing the correlations between the first product to the plurality of other products assessed at prior times;
selecting a subset of products from the set of products based at least in part on the correlation values;
providing the time-series data associated with each product from the subset of products and the first product to a machine learning model trained to predict a future value of the first product based on values of the subset of products at the prior times; and
obtaining, from the machine learning model, prediction data representing a set of predicted values for the first product at one or more future times.

12. The computer readable medium of claim 11, wherein the machine learning model is configured to generate the prediction data for only the first product.

13. The computer readable medium of claim 11, the operations further comprising:
determining a ranking of correlation values from the set of correlation values, wherein the ranking of correlation values indicates which products from the set of products have data trends that are most strongly correlated with a first data trend of the first product,
wherein the subset of products have the top N correlation values from the ranking.

14. The computer readable medium of claim 11, wherein at least one product of the set of products comprises an environmental, social, and governance (ESG) metric, and wherein the ESG metric is one of a carbon metric, an ESG fund ratings metric, or an ESG product involvement metric.

15. The computer readable medium of claim 11, the operations further comprising selecting the machine-learning model based on data dimensions of the time-series data for the set of products, wherein:
when the data dimensions of the time-series data have 2-40 time points per series, select LASSO,
when the data dimensions of the time-series data have 40-5000 time points per series, select Random Forests, and
when the data dimensions of the time-series data have 5000 or more time points per series, select Deep Learning.

16. A method for implementation by at least one programmable processor, the method comprising:
retrieving, for each product of a set of products, the time-series data including a plurality of time-value pairs;
selecting a first product from the set of products;
computing a correlation value between the first product and a plurality of other products from the set of products and for one or more degrees of lag to obtain a set of correlation values representing the correlations between the first product to the plurality of other products assessed at prior times;
selecting a subset of products from the set of products based at least in part on the correlation values;
providing the time-series data associated with each product from the subset of products and the first product to a machine learning model trained to predict a future value of the first product based on values of the subset of products at the prior times; and
obtaining, from the machine learning model, prediction data representing a set of predicted values for the first product at one or more future times.

17. The method of claim 16, wherein the machine learning model is configured to generate the prediction data for only the first product.

18. The method of claim 16, the method further comprising:
determining a ranking of correlation values from the set of correlation values, wherein the ranking of correlation values indicates which products from the set of products have data trends that are most strongly correlated with a first data trend of the first product,
wherein the subset of products have the top N correlation values from the ranking.

19. The method of claim 16, wherein at least one product of the set of products comprises an environmental, social, and governance (ESG) metric, and wherein the ESG metric is one of a carbon metric, an ESG fund ratings metric, or an ESG product involvement metric.

20. The method of claim 16, the method further comprising selecting the machine-learning model based on data dimensions of the time-series data for the set of products, wherein:
when the data dimensions of the time-series data have 2-40 time points per series, select LASSO,
when the data dimensions of the time-series data have 40-5000 time points per series, select Random Forests, and
when the data dimensions of the time-series data have 5000 or more time points per series, select Deep Learning.
